(19) United States
(12) Patent Application Publication
(10) Pub. No.: US 2009/0153663 A1
(43) Pub. Date: Jun. 18, 2009

(54) BACK-UP CAMERA AND INTEGRATED LED LICENSE LIGHT

(76) Inventor: Frank Ramos, Columbus, OH (US)

Correspondence Address: Emerson, Thomson & Bennett, LLC, 777 W. Market Street, Akron, OH, 44303, US

(21) Appl. No.: 11/964,214

(22) Filed: Dec. 26, 2007

Related U.S. Application Data
(60) Provisional application No. 60/878,360, filed on Dec. 31, 2006.

(51) Int. Cl. H04N 7/18

(52) U.S. Cl. 348/148

(57) ABSTRACT

A vehicle rear-vision system for providing the operator scenic information relating to the vehicle's rearview area may be integrated within a common housing with the vehicle's rear license plate light assembly.

This application claims priority from U.S. Ser. No. 60/878,360, titled BACK-UP CAMERA AND INTEGRATED LED LICENSE LIGHT, filed Dec. 31, 2006, which is incorporated herein by reference.

### I. BACKGROUND OF THE INVENTION

A. Field of Invention

This invention pertains to the art of methods and apparatuses regarding the manufacture of vehicles, and more specifically to methods and apparatuses regarding the manufacture of vehicles comprising rear-vision systems having an integrated rear license plate light.

B. Description of the Related Art

It is known to use a rear-vision system to provide a vehicle operator with scenic information of the area located directly rearward of the vehicle (also referred to as the rearview area). This information may be especially useful when the vehicle is traveling in the reverse or rearward direction so that the operator can see any potential interfering objects. Neither interior rear-view mirrors nor side exterior mirrors allow for visibility of the rearview area. Conventionally, the rear-vision system displays the rearview area images as supplementary information for the vehicle operator on a monitoring device located near the vehicle's driver seat.

Known rear-vision systems use a camera with a wide angle lens system to provide a wider angle view of the rearview area. Typically, additional lenses are required to correct image distortion caused at least in part by the extreme field curvature provided by the wide angle lens. These additional lenses further add to the complexity and space required for the rear-vision system.

It is known to provide a vehicle with a rear light assembly. Commonly, a light source, such as a light emitting diode (LED), is used to illuminate a vehicle license plate as an indicator that the vehicle is engaging in a reverse gear and that the vehicle may begin traveling in a reverse or rearward direction. Typically, the light source is located within the rear light assembly and is positioned to irradiate light evenly across the license plate.

Although known rear-vision systems work well for their intended purpose, several disadvantages exist. Conventional rear-vision systems are difficult to package within the small area available at the reward portion of the vehicle. These systems are typically assembled as a horizontal cylindrical column and position within the trunk lid or rear panel of the vehicle. Commonly, the rear-vision system extends into the vehicle's trunk or interior portion thereby undesirably limiting the interior space of the vehicle.

### II. SUMMARY OF THE INVENTION

According to one embodiment of the invention, an integrated rear-vision system and rear light assembly may have a rear-vision system. The rear-vision system may have a camera assembly having at least a first lens assembly and an image capture device; a controller portion; and, a display device; a rear light assembly comprising: a rear housing assembly; a cover assembly comprising a camera aperture and a first light aperture; the cover assembly cooperates with the rear housing assembly to define at least a first light cavity and a camera cavity; and, a first light source is positioned within the first light cavity and emits light through the first light aperture toward a housing opening; and, the camera assembly is positioned within the camera cavity, the camera assembly captures images of a rearview area through the camera aperture, and the images of the rearview area are transmitted to the display device.

According to one embodiment of the invention, an integrated rear-vision system and rear light assembly may have a rear-vision system. The rear-vision system may have a camera assembly having a first lens assembly, a second lens assembly and an image capture device; a controller portion; and, a display device; a rear light assembly comprising: a rear housing assembly; a cover assembly comprising a camera aperture and a first light aperture; the cover assembly cooperates with the rear housing assembly to define at least a first light cavity and a camera cavity; and, a first light source is positioned within the first light cavity and emits light through the first light aperture toward a housing opening; and, the camera assembly is positioned within the camera cavity, the camera assembly captures images of a rearview area through the camera aperture, and the images of the rearview area are transmitted to the display device.

According to one embodiment of the invention, an integrated rear-vision system and rear light assembly may have a rear-vision system. The rear-vision system may have a camera assembly having a first lens assembly, a second lens assembly and an image capture device; a controller portion; and, a display device; a rear light assembly comprising: a rear housing assembly; a cover assembly comprising a camera aperture and a first light aperture; the cover assembly cooperates with the rear housing assembly to define at least a first light cavity and a camera cavity; and, a first light source is positioned within the first light cavity and emits light through the first light aperture toward a housing opening; and, the camera assembly is positioned within the camera cavity, the camera assembly captures images of a rearview area through the camera aperture, and the images of the rearview area are transmitted to tle display device. The first lens assembly comprises a first wide angle lens and a second wide angle lens, and the second lens assembly comprises a first focusing lens, a second focusing lens, and a third focusing lens.

According to one embodiment of the invention, an integrated rear-vision system and rear light assembly may have a rear-vision system. The rear-vision system may have a camera assembly having a first lens assembly, a second lens assembly and an image capture device; a controller portion; and, a display device; a rear light assembly comprising: a rear housing assembly; a cover assembly comprising a camera aperture and a first light aperture; the cover assembly cooperates with the rear housing assembly to define at least a first light cavity and a camera cavity; and, a first light source is positioned within the first light cavity and emits light through the first light aperture toward a housing opening; and, the camera assembly is positioned within the camera cavity, the camera assembly captures images of a rearview area through the camera aperture, and the images of the rearview area are transmitted to the display device. The first lens assembly comprises a first wide angle lens and a second wide angle lens, and the second lens assembly comprises a first focusing lens, a second focusing lens, and a third focusing lens. The first wide angle lens, the second wide angle lens and the first focusing lens each comprise a diverging optic element.

According to one embodiment of the invention, an integrated rear-vision system and rear light assembly may have a rear-vision system. The rear-vision system may have a camera assembly having a first lens assembly, a second lens assembly and an image capture device; a controller portion; and, a display device; a rear light assembly comprising: a rear housing assembly; a cover assembly comprising a camera aperture and a first light aperture; the cover assembly cooperates with the rear housing assembly to define at least a first light cavity and a camera cavity; and, a first light source is positioned within the first light cavity and emits light through the first light aperture toward a housing opening; and, the camera assembly is positioned within the camera cavity, the camera assembly captures images of a rearview area through the camera aperture, and the images of the rearview area are transmitted to the display device. The first lens assembly comprises a first wide angle lens and a second wide angle lens, and the second lens assembly comprises a first focusing lens, a second focusing lens, and a third focusing lens. The second focusing lens and the third focusing lens each comprise a converging optic element.

According to one embodiment of the invention, an integrated rear-vision system and rear light assembly may have a rear-vision system. The rear-vision system may have a camera assembly having at least a first lens assembly and an image capture device; a controller portion; and, a display device; a rear light assembly comprising: a rear housing assembly; a cover assembly comprising a camera aperture, a first light aperture, and a second light aperture. The cover assembly cooperates with the rear housing assembly to define a first light cavity, a second light cavity, and a camera cavity; and, a first light source is positioned within the first light cavity and emits light through the first light aperture toward a housing opening, a second light source is positioned within the second light cavity and emits a light through the second light aperture toward the housing opening; and, the camera assembly is positioned within the camera cavity, the camera assembly captures images of a rearview area through the camera aperture, and the images of the rearview area are transmitted to the display device.

According to one embodiment of the invention, an integrated rear-vision system and rear light assembly may have a rear-vision system. The rear-vision system may have a camera assembly having at least a first lens assembly and an image capture device; a controller portion; and, a display device; a rear light assembly comprising: a rear housing assembly; a cover assembly comprising a camera aperture, a third light aperture, and a first light aperture; the cover assembly cooperates with the rear housing assembly to define a first light cavity, a third light cavity, and a camera cavity; and, a first light source is positioned within the first light cavity and emits light through the first light aperture toward a housing opening; a third light source is positioned within the third light cavity and the third light source emits a light through the third light aperture toward the rearview area; and, the camera assembly is positioned within the camera cavity, the camera assembly captures images of a rearview area through the camera aperture, and the images of the rearview area are transmitted to the display device.

According to one embodiment of the invention, a vehicle comprises a rear-facing end and an integrated rear-vision system and rear light assembly. The integrated rear-vision system and rear light assembly comprises a rear-vision system and a rear light assembly. The rear-vision system comprises a camera assembly mounted to the vehicle, comprising at least a first lens assembly and an image capture device; a controller portion mounted to the vehicle; and, a display device mounted to the vehicle. The rear light assembly is mounted to the rear-facing end of the vehicle and comprises a rear housing assembly, a cover assembly comprising a camera aperture and a first light aperture. The cover assembly cooperates with the rear housing assembly to define at least a first light cavity and a camera cavity. A first light source is positioned within the first light cavity and emits a light through the first light aperture toward a housing opening. The camera assembly is positioned within the camera cavity, the camera assembly captures images of a rearview area through the camera aperture, and the images of the rearview area are transmitted to the display device.

According to one embodiment of the invention, a vehicle comprises a rear-facing end and an integrated rear-vision system and rear light assembly. The integrated rear-vision system and rear light assembly comprises a rear-vision system and a rear light assembly. The rear-vision system comprises a camera assembly mounted to the vehicle, comprising a first lens assembly, a second lens assembly, and an image capture device; a controller portion mounted to the vehicle; and, a display device mounted to the vehicle. The rear light assembly is mounted to the rear-facing end of the vehicle and comprises a rear housing assembly, a cover assembly comprising a camera aperture and a first light aperture. The cover assembly cooperates with the rear housing assembly to define at least a first light cavity and a camera cavity. A first light source is positioned within the first light cavity and emits a light through the first light aperture toward a housing opening. The camera assembly is positioned within the camera cavity, the camera assembly captures images of a rearview area through the camera aperture, and the images of the rearview area are transmitted to the display device.

According to one embodiment of the invention, a vehicle comprises a rear-facing end and an integrated rear-vision system and rear light assembly. The integrated rear-vision system and rear light assembly comprises a rear-vision system and a rear light assembly. The rear-vision system comprises a camera assembly mounted to the vehicle, comprising a first lens assembly, a second lens assembly, and an image capture device; a controller portion mounted to the vehicle; and, a display device mounted to the vehicle. The first lens assembly comprises a first wide angle lens and a second wide angle lens. The second lens assembly comprises a first focusing lens, a second focusing lens, and a third focusing lens. The rear light assembly is mounted to the rear-facing end of the vehicle and comprises a rear housing assembly, a cover assembly comprising a camera aperture and a first light aperture. The cover assembly cooperates with the rear housing assembly to define at least a first light cavity and a camera cavity. A first light source is positioned within the first light cavity and emits a light through the first light aperture toward a housing opening. The camera assembly is positioned within the camera cavity, the camera assembly captures images of a rearview area through the camera aperture, and the images of the rearview area are transmitted to the display device.

According to one embodiment of the invention, a vehicle comprises a rear-facing end and an integrated rear-vision system and rear light assembly. The integrated rear-vision system and rear light assembly comprises a rear-vision system and a rear light assembly. The rear-vision system comprises a camera assembly mounted to the vehicle, comprising a first lens assembly, a second lens assembly, and an image capture device; a controller portion mounted to the vehicle; and, a display device mounted to the vehicle. The first lens assembly comprises a first wide angle lens and a second wide angle lens. The second lens assembly comprises a first focusing lens, a second focusing lens, and a third focusing lens. The first wide angle lens, the second wide angle lens, and the first focusing lens each comprise a diverging optic element. The rear light assembly is mounted to the rear-facing end of the vehicle and comprises a rear housing assembly, a cover assembly comprising a camera aperture and a first light aperture. The cover assembly cooperates with the rear housing assembly to define at least a first light cavity and a camera cavity. A first light source is positioned within the first light cavity and emits a light through the first light aperture toward a housing opening. The camera assembly is positioned within the camera cavity, the camera assembly captures images of a rearview area through the camera aperture, and the images of the rearview area are transmitted to the display device.

According to one embodiment of the invention, a vehicle comprises a rear-facing end and an integrated rear-vision system and rear light assembly. The integrated rear-vision system and rear light assembly comprises a rear-vision system and a rear light assembly. The rear-vision system comprises a camera assembly mounted to the vehicle, comprising a first lens assembly, a second lens assembly, and an image capture device; a controller portion mounted to the vehicle; and, a display device mounted to the vehicle. The first lens assembly comprises a first wide angle lens and a second wide angle lens. The second lens assembly comprises a first focusing lens, a second focusing lens, and a third focusing lens. The second focusing lens and the third focusing lens each comprise a converging optic element. The rear light assembly is mounted to the rear-facing end of the vehicle and comprises a rear housing assembly, a cover assembly comprising a camera aperture and a first light aperture. The cover assembly cooperates with the rear housing assembly to define at least a first light cavity and a camera cavity. A first light source is positioned within the first light cavity and emits a light through the first light aperture toward a housing opening. The camera assembly is positioned within the camera cavity, the camera assembly captures images of a rearview area tlirough the camera aperture, and the images of the rearview area are transmitted to the display device.

According to one embodiment of the invention, a vehicle comprises a rear-facing end and an integrated rear-vision system and rear light assembly. The integrated rear-vision system and rear light assembly comprises a rear-vision system and a rear light assembly. The rear-vision system comprises a camera assembly mounted to the vehicle, comprising at least a first lens assembly and an image capture device; a controller portion mounted to the vehicle; and, a display device mounted to the vehicle. The rear light assembly is mounted to the rear-facing end of the vehicle and comprises a rear housing assembly, a cover assembly comprising a camera aperture, a second light aperture, and a first light aperture. The cover assembly cooperates with the rear housing assembly to define a first light cavity, a second light cavity, and a camera cavity. A first light source is positioned within the first light cavity and emits a light through the first light aperture toward a housing opening. A second light source is positioned within the second light cavity and emits a light through the second light aperture toward the housing opening. The camera assembly is positioned within the camera cavity, the camera assembly captures images of a rearview area through the camera aperture, and the images of the rearview area are transmitted to the display device.

According to one embodiment of the invention, a vehicle comprises a rear-facing end and an integrated rear-vision system and rear light assembly. The integrated rear-vision system and rear light assembly comprises a rear-vision system and a rear light assembly. The rear-vision system comprises a camera assembly mounted to the vehicle, comprising at least a first lens assembly and an image capture device; a controller portion mounted to the vehicle; and, a display device mounted to the vehicle. The rear light assembly is mounted to the rear-facing end of the vehicle and comprises a rear housing assembly, a cover assembly comprising a camera aperture, a third light aperture, and a first light aperture. The cover assembly cooperates with the rear housing assembly to define a first light cavity, a third light cavity, and a camera cavity. A first light source is positioned within the first light cavity and emits a light through the first light aperture toward a housing opening. A third light source is positioned within the third light cavity and emits a light through the third light aperture toward the rearview area. The camera assembly is positioned within the camera cavity, the camera assembly captures images of a rearview area through the camera aperture, and the images of the rearview area are transmitted to the display device.

According to one embodiment of the invention, a method comprises the steps of: (a) providing a vehicle; (b) providing an integrated rear-vision system and rear light assembly mounted to the vehicle and comprising: a rear-vision system comprising: (i) a camera assembly comprising at least a first lens assembly and an image capture device; (ii) a controller portion; and, (iii) a display device; a rear light assembly comprising: (i) a rear housing assembly; (ii) a cover assembly comprising a camera aperture and a first light aperture; and, (iii) the cover assembly cooperates with the rear housing assembly to define at least a first light cavity and a camera cavity; (b) positioning a first light source within the first light cavity such that the first light source emits light through the first light aperture toward a housing opening; (c) positioning the camera assembly within the camera cavity; (d) capturing images of a rearview area through the camera aperture; and, (e) transmitting the images of the rearview area to the display device.

According to one embodiment of the invention, a method comprises the steps of: (a) providing a vehicle; (b) providing an integrated rear-vision system and rear light assembly mounted to the vehicle and comprising: a rear-vision system comprising: (i) a camera assembly comprising at least a first lens assembly and an image capture device; (ii) a controller portion; and, (iii) a display device; a rear light assembly comprising: (i) a rear housing assembly; (ii) a cover assembly comprising a camera aperture and a first light aperture; and, (iii) the cover assembly cooperates with the rear housing assembly to define at least a first light cavity and a camera cavity; (b) positioning a first light source within the first light cavity such that the first light source emits light through the first light aperture toward a housing opening; (c) positioning the camera assembly within the camera cavity; (d) capturing images of a rearview area through the camera aperture; and, (e) transmitting the images of the rearview area to the display device over a fiber optic cable.

According to one embodiment of the invention, a method comprises the steps of: (a) providing a vehicle; (b) providing an integrated rear-vision system and rear light assembly mounted to the vehicle and comprising: a rear-vision system comprising: (i) a camera assembly comprising at least a first lens assembly and an image capture device; (ii) a controller portion; and, (iii) a display device; a rear light assembly comprising: (i) a rear housing assembly; (ii) a cover assembly comprising a camera aperture and a first light aperture; and, (iii) the cover assembly cooperates with the rear housing assembly to define at least a first light cavity and a camera cavity; (b) positioning a first light source within the first light cavity such that the first light source emits light through the first light aperture toward a housing opening and positioning a second light source within a second light cavity such that the second light source emits light through a second light aperture toward the housing opening, wherein the cover assembly comprises the second light aperture and the cover assembly cooperates with the rear housing assembly to form the second light cavity; (c) positioning the camera assembly within the camera cavity; (d) capturing images of a rearview area through the camera aperture; and, (e) transmitting the images of the rearview area to the display device.

One advantage of this invention is the space required to package the rear-vision system is reduced to substantially that already required for the vehicle's rear light assembly.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a back perspective view of a vehicle having an integrated rear-vision system and rear light assembly according to one embodiment of the invention.

FIG. 2 is a side view of the back end of a vehicle having an integrated rear-vision system and rear light assembly according to one embodiment of the invention illustrating The rearview area of the vehicle.

FIG. 3 is an exploded side perspective view of an integrated rear-vision system and rear light assembly according to one embodiment of the invention.

FIG. 4 is a side view of a lens assembly of an integrated rear-vision system and rear light assembly according to one embodiment of the invention.

FIG. 5 is a perspective assembly view of a rear light assembly of an integrated rear-vision system and rear light assembly according to one embodiment of the invention.

FIG. 6 is a partial side perspective view of a light cavity and a license plate light according to one embodiment of the invention.

FIG. 7 is a perspective view of a display device positioned within the interior portion of a vehicle according to one embodiment of the invention.

### IV. DETAILED DESCRIPTION OF THE INVENTION

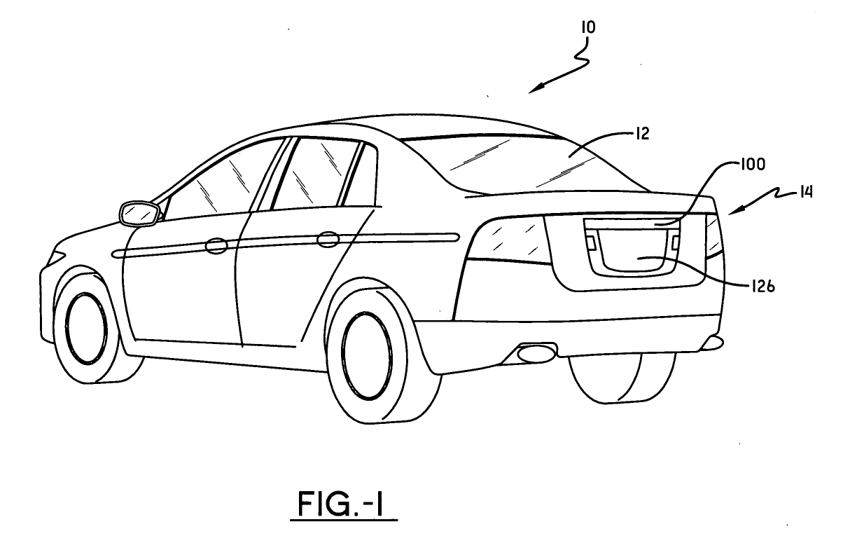

Referring now to the drawings wherein the showings are for purposes of illustrating embodiments of the invention only and not for purposes of limiting the same, FIG. 1 shows a vehicle 10 equipped with an integrated rear-vision system and rear light assembly 100 according to one embodiment of the invention. The vehicle 10 may have a vehicle rear tailgate or rear-facing end 12 and a license plate area 14 where a license plate (not shown) may be mounted. Although a passenger vehicle 10 is depicted, it is to be understood that the integrated rear-vision system and rear light assembly 100 of this invention may be utilized with any type of vehicle chosen with sound engineering judgment.

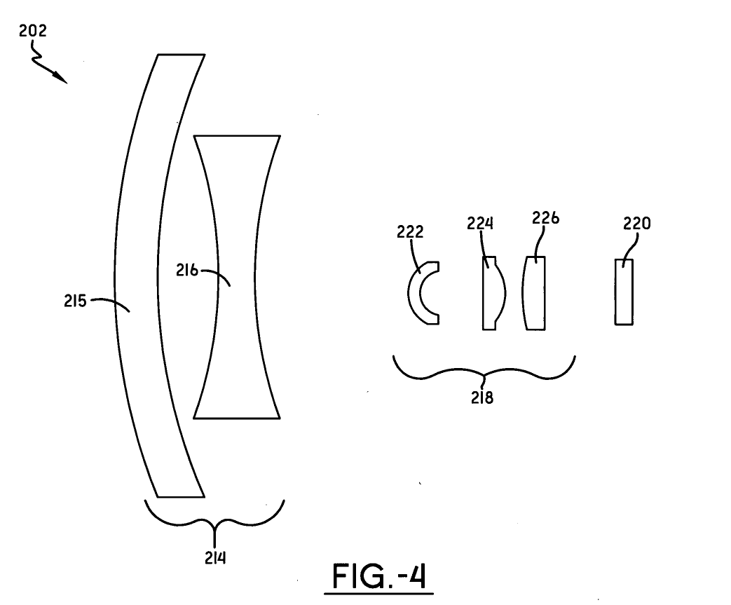

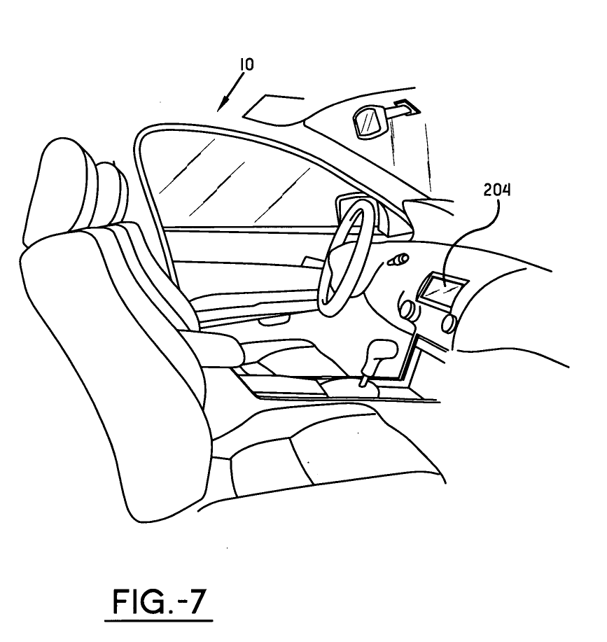

With reference now to FIGS. 1-4, 7, the integrated rear-vision system and rear light assembly 100 may comprise a rear light assembly 110 and a rear-vision system 200. The rear-vision system 200 may comprise a camera assembly 202, a controller portion 203, and a display device 204 (shown in FIG. 7) Rear-vision systems for providing the operator of the vehicle 10 with scenic information of the rearview area 11 are well known in the art and will only be briefly and generally described here. The controller portion 203 may comprise a microprocessor or central processing unit (not shown) and a memory portion (not shown). The central processing unit may control the movement of the component comprising the rear-vision system 200 by executing application programs, stored on the memory portion, for controlling the cameral assembly 202 and the display device 204.

With reference now to FIGS. 1-4, the camera assembly 202 may comprise at least a first lens assembly suitable for providing scenic information of the rearview area 11. In one embodiment, the camera assembly 202 may comprise a wide angle lens assembly 214, a focusing lens assembly 218, and an image capture device 220. The wide angle lens assembly 214 may provide a virtual image of a wide angle view of the rearview area to the focusing lens assembly 218. The wide angle lens assembly 214 may comprise a first wide angle lens 215 and a second wide angle lens 216. The first wide angle lens 215 may be a diverging or negative optic element such that a virtual, wide-angle image of the rearview area 11 is refracted through the first wide angle lens 215 toward the second wide angle lens 216. The second wide angle lens 216 may also comprise a negative optic element such that the image is further refracted through the second wide angle lens 216 toward the focusing lens assembly 218. The focusing lens assembly 218 may receive the image refracted through the wide angle lens assembly 214 and may then focus the image onto the image capture device 220.

With reference now to FIGS. 1-4, 7, the focusing lens assembly 218 may comprise an outer focusing lens 222, a center focusing lens 224, and an inner focusing lens 226. The outer focusing lens 222 may comprise a negative or diverging optic that is convexly curved toward the wide angle lens assembly 214. The outer focusing lens 222 may receive the refracted image form the wide angle lens assembly 214 and may function to partially correct the images as the image is refracted and inverted through the outer focusing lens 222 toward the center focusing lens 224. The center focusing lens 224 may comprise a positive or converging optic and may receive an inverted image from the outer focusing lens 222. The middle focusing lens 224 may refract and direct the image toward the inner focusing lens 226. The inner focusing element 226 may comprise a positive optic and may receive the image from the middle focusing element 224. The inner focusing lens 226 may direct the image towards the image capture device 220. The image capture device 220 may comprise a pixilated-imaging array and may receive the image from the focusing lens assembly 218. In one embodiment, the image capture device 220 may comprise a charged coupled device (CCD) camera or imaging array. The controller portion 203 may at least partially cause the image capture device 220 to transmit the image to the display device 204. The image capture device 220 may transmit the image over any form of transmission media such as fiber optic cables or the like. The display device 204 may be positioned within the vehicle 10 such that the display device 204 may be easily viewed by a vehicle operator. In one embodiment, the display device 204 may be positioned within a vehicle front panel 205 (as shown in FIG. 7). The display device 204 may comprise any device suitable for displaying the captured images to the vehicle operator, such as a liquid crystal display (LCD).

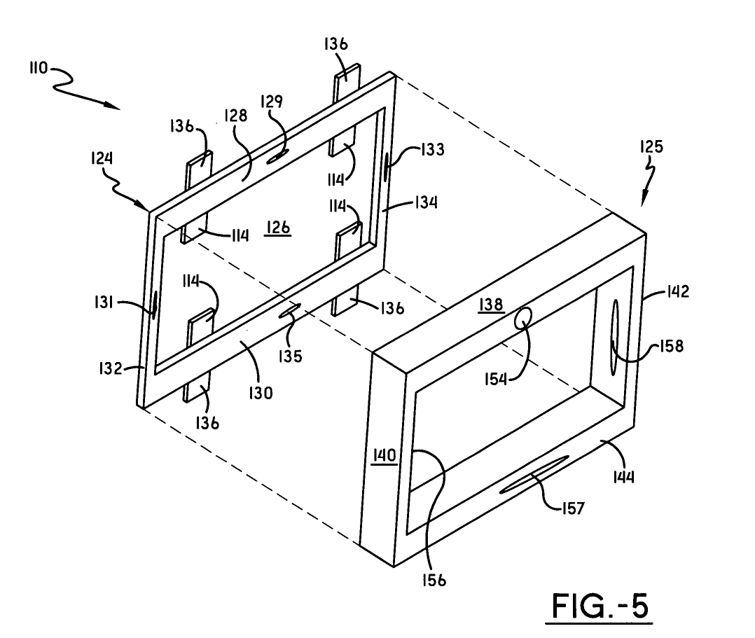

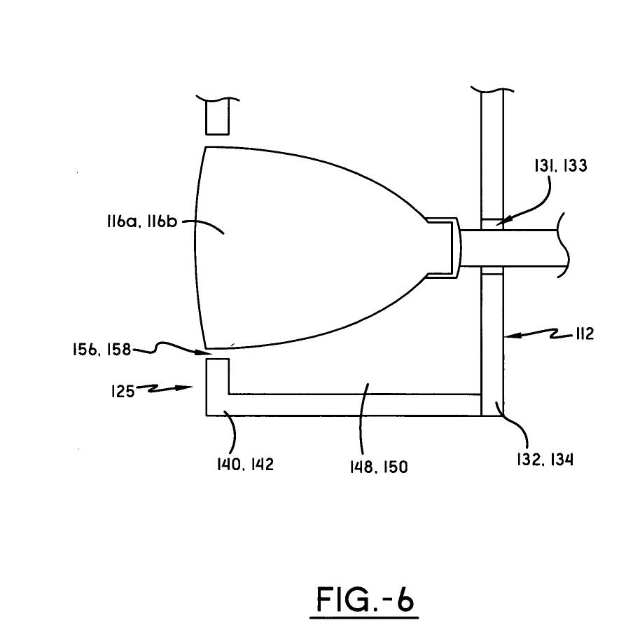

With reference now to FIGS. 1 and 5-6, the rear light assembly 110 may comprise a rear housing assembly 112 and a camera cover portion 125. Rear light assemblies are well known in the art and therefore will only be briefly and generally described herein. The rear housing assembly 112 may comprise a generally rectangular frame that defines the license plate area 14 which has a housing opening 126. The rear housing assembly 112 may comprise a license plate mounting portion 114, an upper portion 128, a lower portion 130, a first side portion 132, and a second side portion 134. The first side portion 132 and the second side portion 134 may extend between the upper portion 128 and the lower portion 130 thereby defining the housing opening 126. The license plate mounting portion 114 may be positioned within the housing opening 126 and may be configured to receive or engage a license plate (not shown) and may be sized and shaped accordingly as is well known in the art. The rear housing assembly 112 may also comprise a plurality of mounting tabs 136. The plurality of mounting tabs 136 may be positioned along the upper portion 128 and the lower portion 130 to receiving a conventional fastener, such as a screw, for attaching the base frame 124 to the vehicle tailgate or end 12. The upper portion 128, the lower portion 130, the first side portion 132, and the second side portion 134 may each comprise at least a first wire harness aperture 129, 131, 133, 135 that allows for the electrical coupling of the components of the integrated rear-vision system and rear light assembly 100.

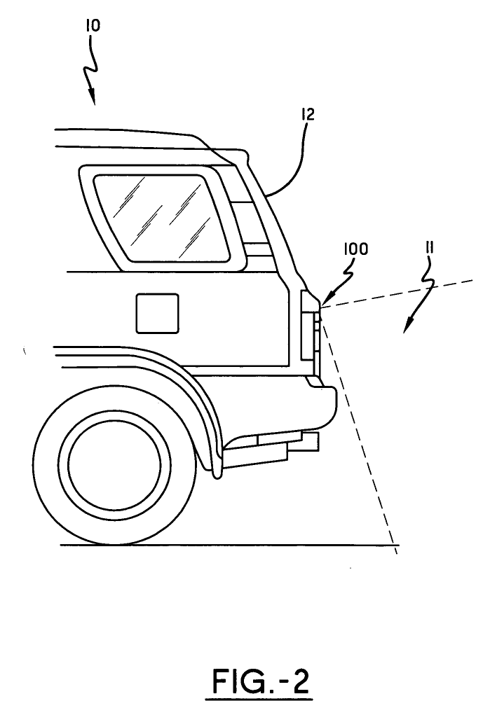

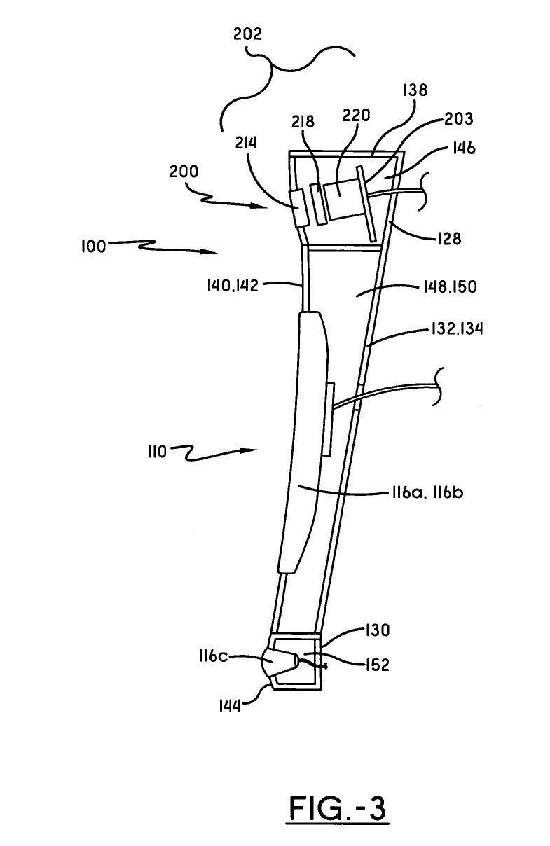

With reference now to FIGS. 2-6, the cover assembly 125 may comprise a generally rectangular shape that compliments the shape of the rear housing assembly 112. The cover assembly 125 may comprise an upper segment 138, a first side segment 140, a second side segment 142, and a bottom segment 144. The upper segment 138 may cooperate with the upper portion 128 to define a camera cavity 146 (as shown in FIG. 3). The first or second side segments 140, 142 may cooperate with the first or the second side portion 132, 134 to define a first light cavity 148. In another embodiment, both the first and the second side segments 140, 142 may cooperate with the first and second side portions 132, 134 to define a first light cavity 148 and a second light cavity 150 respectively. In yet another embodiment, the bottom segment 144 may additionally cooperate with die lower portion 130 to form a bottom cavity 152. The upper segment 138 may comprise a camera aperture 154. The wide angle lens assembly 214 may be positioned adjacent to the camera aperture 154 such that the camera assembly 202 can capture virtual images of the rearview area 11 through the camera aperture 154.

With continued reference to FIGS. 2-6, in one embodiment, first and second license plate lights 116a, 116b may be positioned within the first and second light cavities 148, 150 respectively. A third light source 116c may be positioned within the bottom cavity 152 to illuminate the rearview area through a third light aperture 157 formed in the bottom segment 144 during low light conditions. The first and second license plate lights 116a, 116b and the third light source 116c may comprise a light emitting diode (LED) that emits a light directed toward the housing opening 126. In one embodiment, the first and second license plate lights 116a, 116b may emit a white light. In another embodiment, the first and second license plate lights 116a, 116b may emit a yellow or pale blue light. The first and second license plate lights 116a, 116b may emit any color light chosen with sound engineering judgment. The rear light assembly 110 may comprise any number of license plate lights located in any position with the rear light assembly 110 chosen with sound engineering judgment. The first and second license plate lights 116a, 116b may emit light directed at the housing opening 126 through a first and second light aperture 156, 158 formed in the first and second side segments 140, 142.

Various embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

I/We claim:

1. An integrated rear-vision system and rear light assembly comprising:
a rear-vision system comprising:
(a) a camera assembly comprising at least a first lens assembly and an image capture device;
(b) a controller portion; and,
(c) a display device;
a rear light assembly comprising:
(a) a rear housing assembly;
(b) a cover assembly comprising a camera aperture and a first light aperture;
(c) the cover assembly cooperates with the rear housing assembly to define at least a first light cavity and a camera cavity; and,
(d) a first light source is positioned within the first light cavity and emits light through the first light aperture toward a housing opening; and,
the camera assembly is positioned within the camera cavity, the camera assembly captures images of a rearview area through the camera aperture, and the images of the rearview area are transmitted to the display device.

2. The integrated rear-vision system and rear light assembly of claim 1, wherein the camera assembly further comprises:
a second lens assembly.

3. The integrated rear-vision system and rear light assembly of claim 2, wherein:
the first lens assembly comprises a first wide angle lens and a second wide angle lens; and,
the second lens assembly comprises a first focusing lens, a second focusing lens, and a third focusing lens.

4. The integrated rear-vision system and rear light assembly of claim 3, wherein the first wide angle lens, the second wide angle lens and the first focusing lens each comprise a diverging optic element.

5. The integrated rear-vision system and rear light assembly of claim 3, wherein the second focusing lens and the third focusing lens each comprise a converging optic element.

6. The integrated rear-vision system and rear light assembly of claim 1, wherein:
the cover assembly further comprises a second light aperture;
the cover assembly cooperates with the rear housing assembly to form a second light cavity; and,
a second light source is positioned within the second light cavity and the second light source emits a light through the second light aperture toward the housing opening.

7. The integrated rear-vision system and rear light assembly of claim 1, wherein:
the cover assembly further comprises a third light aperture;
the cover assembly cooperates with the rear housing assembly to form a third light cavity; and,
a third light source is positioned within the third light cavity and the third light source emits a light through the third light aperture toward the rearview area.

8. A vehicle comprising:
a rear-facing end; and,
an integrated rear-vision system and rear light assembly comprising.
a rear-vision system comprising:
(a) a camera assembly mounted to the vehicle, comprising at least a first lens assembly and an image capture device;
(b) a controller portion mounted to the vehicle; and,
(c) a display device mounted to the vehicle;
a rear light assembly mounted to the rear-facing end of the vehicle, comprising:
(a) a rear housing assembly;
(b) a cover assembly comprising a camera aperture and a first light aperture;
(c) the cover assembly cooperates with the rear housing assembly to define at least a first light cavity and a camera cavity; and,
(d) a first light source is positioned within the first light cavity and emits light through the first light aperture toward a housing opening; and,
the camera assembly is positioned within the camera cavity, the camera assembly captures images of a rearview area through the camera aperture, and the images of the rearview area are transmitted to the display device.

9. The vehicle of claim 8, wherein the camera assembly further comprises:
a second lens assembly.

10. The vehicle of claim 9, wherein:
the first lens assembly comprises first wide angle lens and a second wide angle lens; and,
the second lens assembly comprises a first focusing lens, a second focusing lens, and a third focusing lens.

11. The vehicle of claim 10, wherein the first wide angle lens, the second wide angle lens and the first focusing lens each comprise a diverging optic element.

12. The vehicle of claim 10, wherein the second focusing lens and the third focusing lens each comprise a converging optic element.

13. The vehicle of claim 8, wherein:
the cover assembly further comprises a second light aperture;
the cover assembly cooperates with the rear housing assembly to form a second light cavity; and,
a second light source is positioned within the second light cavity and the second light source emits a light through the second light aperture toward the housing opening.

14. The vehicle of claim 8, wherein:
the cover assembly further comprises a third light aperture;
the cover assembly cooperates with the rear housing assembly to form a third light cavity; and,
a third light source is positioned within the third light cavity and the third light source emits a light through the third light aperture toward the rearview area.

15. A method comprising the steps of:
(a) providing a vehicle;
(b) providing an integrated rear-vision system and rear light assembly mounted to the vehicle and comprising:
a rear-vision system comprising.
(i) a camera assembly comprising at least a first lens assembly and an image capture device;
(ii) a controller portion; and,
(iii) a display device;
a rear light assembly comprising:
(i) a rear housing assembly;
(ii) a cover assembly comprising a camera aperture and a first light aperture; and,
(iii) the cover assembly cooperates with the rear housing assembly to define at least a first light cavity and a camera cavity;
(b) positioning a first light source within the first light cavity such that the first light source emits light through the first light aperture toward a housing opening;
(c) positioning the camera assembly within the camera cavity;
(d) capturing images of a rearview area through the camera aperture; and,
(e) transmitting the images of the rearview area to the display device.

16. The method of claim 15, wherein step (e) further comprises the step of:
transmitting the images of the rearview area to the display device over a fiber optic cable.

17. The method of claim 15, wherein step (b) further comprises the step of:
positioning a second light source within a second light cavity such that the second light source emits light through a second light aperture toward the housing opening, wherein the cover assembly comprises the second light aperture and the cover assembly cooperates with the rear housing assembly to form the second light cavity.
